(19) United States
(12) Patent Application Publication
(10) Pub. No.: US 2015/0089566 A1
(43) Pub. Date: Mar. 26, 2015

(54) ESCALATION SECURITY METHOD FOR USE IN SOFTWARE DEFINED NETWORKS

(71) Applicant: RADWARE, LTD., Tel Aviv (IL)

(72) Inventor: Avi CHESLA, Tel Aviv (IL)

(73) Assignee: RADWARE, LTD., Tel Aviv (IL)

(21) Appl. No.: 14/035,367

(22) Filed: Sep. 24, 2013

(51) Int. Cl. H04L 29/06

(52) U.S. Cl. CPC H04L 63/20
USPC 726/1

(57) ABSTRACT

A method for performing an escalation security policy in a software defined network (SDN) includes receiving at least one attack indication performed against at least one destination server; upon determination that an attack is being performed against the at least one destination server, for each client sending traffic to the at least one destination server: determining a risk state for a user of the each client; obtaining an escalation security policy respective of the determined risk state of the user, wherein the escalation security policy defines a sequence of at least one challenge action for challenging the each client, an order and at least one condition for execution of the sequence of at least one challenge action; and causing network elements of the SDN to divert incoming traffic from the each client to security servers connected to the SDN and configured to perform the at least one challenge action.

### TECHNICAL FIELD

This invention generally relates to implementation of security techniques in software defined networks, and particularly to the implementation of escalation techniques in such networks.

### BACKGROUND

A significant problem facing the Internet community is that on-line businesses and organizations are vulnerable to malicious attacks. Recently, attacks have been committed using a wide arsenal of attack techniques and tools targeting both the information maintained by the online businesses and their IT infrastructure. For example, recently identified attacks were committed using a combination of attack techniques at the network and application levels. Attackers use different tools to execute different attack techniques. Each such attack tool is designed to exploit weaknesses identified in one of the target's defense layers.

One type of security system solution is designed to mitigate attacks by authenticating the users accessing a protected resource (e.g., a server). Specifically, under the possibility that a malicious malware runs on the client, such a solution also verifies that the transaction is initiated by a legitimate client application (e.g., web browser) and is under control of the user.

Actions known in the art for verifying that a transaction is performed by a legitimate web browser application under the control of a user (a human) are challenge-responses actions. Examples for such tests are a SYN cookie, drop client request and validate legitimate request retransmit, a web redirect (e.g., 302 HTTP redirect message), a JavaScript redirect, CAPTCHA, and the like. In a CAPTCHA action, an image is sent to the user device. The image includes alphanumeric characters that are difficult to recognize for an OCR program, but are visible to a human. The user is authenticated if the characters as entered by the user correspond to the characters in the image. The redirect message invites the browser on the client device to respond to such a message by a request to a new URL specified in the redirected message. The SYN cookie techniques validate the IP address of the client issuing the transaction.

The CAPTCHA action is determined to be more effective, over the other action, in confirming that the transaction is issued by a human and not malware. However, at the same time, this technique negatively affects the user experience while accessing the web services. The SYN cookie action, on the other hand, may be bypassed by an attack tool (or an application) that owns a real IP address (not a spoofed address), yet when applied the user experience remain unchanged. Typically, “aggressive” authentication actions, such as CAPTCHA and JavaScript redirects result in a higher false positive percentage. That is, legit users will be detected as authenticated mainly because the user may decline the execution of the action. For example, the user prevents script processing by the browser or cannot correctly read the image displayed by means of the CAPTCHA.

Escalation security policies define the order in which the authentication actions will be executed. Such policies are defined to maximize the security protection while minimizing the disturbances to the user's browsing activity and the number of false positives. For example, the escalation security policy would define a first action as a SYN cookie and gradually apply different actions, e.g., Java script redirect, until reaching the CAPTCHA action which is the most aggressive action.

In security systems discussed in the related art, the execution of the escalation security policies is typically performed by an application firewall or a security monitor deployed in the line of traffic between the clients and web servers. As such, conventional security systems implementing escalation policies have a few limitations. Specifically, such systems cannot scale to support more clients as the security monitor conducting the escalation is typically a non-distributed solution. The security monitor provides a single point of network failure as being deployed in-line of traffic. Furthermore, such deployment deems the processing of every transaction even when security escalation should not be taken. In addition, current security systems supporting escalation are not designed to efficiently support high availability capabilities and require prolonged downtime when upgrading the escalation security policies and/or authentication actions defined therein. As a result, frequent updates are prevented although such updates are very much needed in order to address new and evolving threats.

Furthermore, the conventional escalation techniques and security systems discussed in the related art are not designed to operate in distributed, virtual, and programmable networks. An example for such a network is a software defined network (SDN).

A SDN is a relatively new type of networking architecture that provides centralized management of network elements rather than a distributed architecture utilized by conventional networks. That is, in the SDN, a network element follows routing, or switching, decisions received from a central controller. In one configuration of a SDN, the central controller communicates with the network elements using an OpenFlow protocol which allows adding programmability to network elements for the purpose of packets-processing operations under the control of the central controller. Traffic received by a network element that supports the OpenFlow protocol is processed and routed according to a set of rules defined by the central controller based on the characteristic of the required network operation. Such a network element routes traffic according to, for example, a flow table and occasionally sends packets to the central controller. Each network element is programmed with a flow table and can be modified by the central controller as required. The operation of network elements and the definition of flow tables according to the OpenFlow protocol are further described in various OpenFlow Switch Specifications issued by the Open Networking Foundation.

As can be understood from the above discussion, the SDN can support dynamic (per need) connectivity to protected servers practically in any location of the network. Thus, the conventional in-line deployment of a device implementing a security escalation technique is not feasible and cannot be operable in a central controller of SDN networks.

Therefore, it would be advantageous to provide a solution for implementing security escalation techniques in SDN-based networks.

### SUMMARY

Certain embodiments disclosed herein include a method for performing an escalation security policy in a software defined network (SDN), the method is being performed by a central controller of the SDN. The method comprises receiving at least one attack indication performed against at least one destination server; upon determination, respective of at least one attack indication, that an attack is being performed against the at least one destination server, for each client sending traffic to the at least one destination server: determining a risk state for a user of the each client; obtaining an escalation security policy respective of the determined risk state of the user, wherein the escalation security policy defines a sequence of at least one challenge action for challenging the each client, an order and at least one condition for execution of the sequence of at least one challenge action; and causing network elements of the SDN to divert incoming traffic from the each client to security servers connected to the SDN and configured to perform the at least one challenge action.

Certain embodiments disclosed herein include a system for performing an escalation security policy in a software defined network (SDN). The system comprises a processor; a network-interface module for communicating with the SDN; a memory connected to the processor and configured to contain a plurality of instructions that when executed by the processor configure the system to: receive at least one attack indication performed against at least one destination server; upon determination, respective of at least one attack indication, that an attack is being performed against the at least one destination server, for each client sending traffic to the at least one destination server: determine a risk state for a user of the each client; obtain an escalation security policy respective of the determined user risk state, wherein the escalation security policy defines a sequence of at least one challenge action for challenging the each client, an order and at least one condition for execution of the sequence of at least one challenge action; and cause network elements of the SDN to divert incoming traffic from the each client to security servers connected to the SDN and configured to perform the at least one challenge action.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 illustrates a diagram of a SDN utilized to describe the various disclosed embodiments.

FIG. 2 is a diagram illustrating user state machines corresponding to escalation policies defined for users and maintained in the central controller 101.

FIGS. 3A, 3B, and 3C illustrate diagrams for the operation of the disclosed escalation method when processing traffic from one client according to one embodiment.

FIGS. 4A and 4B illustrate diagrams for the operation of the disclosed escalation method when the escalation policy is executed for two different clients according to one embodiment.

FIG. 5 is a flowchart illustrating the operation of the escalation method disclosed in accordance to one embodiment.

FIG. 6 is flowchart illustrating the execution of an escalation policy disclosed in accordance to one embodiment.

FIG. 7 is a block diagram of the central controller constructed according to one embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

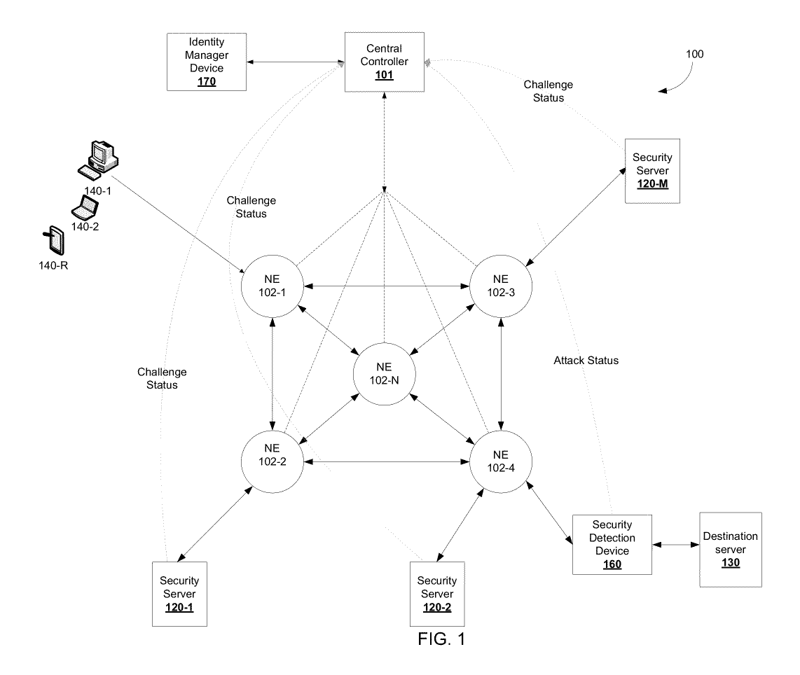

FIG. 1 is an exemplary and non-limiting diagram illustrating a topology of a SDN-based network (hereinafter SDN) 100 utilized to describe the various embodiments discussed herein. The SDN 100 includes a central controller 101 and a plurality of network elements 102-1 through 102-N. To the SDN 100 are further connected a plurality of security servers 120-1 through 120-M, a destination server 130, and a plurality of clients 140-1 through 140-R that communicate with the destination server 130 through the SDN 100. The destination server 130 and the plurality of security servers 120-1 through 120-M may be operable in a cloud-system infrastructure, a hosting server datacenter, service provider networks, or a cooperative network.

The clients may be connected to the SDN through a conventional network which is external to the SDN. Such a network may be, for example, a WAN, the Internet, an Internet service provider (ISP) backbone, and the like. The SDN 100 can be implemented as wide area networks (WANs), local area networks (LANs), service provider backbones, datacenters, inter-datacenter networks, a private cloud, a public cloud, a hybrid cloud, and the like. It should be noted that although one destination server is depicted in FIG. 1 merely for the sake of simplicity, the embodiments disclosed herein can be applied to a plurality of servers, datacenters, and the like. The central controller 100 in addition to the tasks discussed in detail here is also configured to control the SDN and its network element. That is, the central controller 100 can also perform the tasks of a SDN network controller.

The security servers 120 are configured to perform security authentication challenge actions. As discussed in detail above such actions include, for example, a SYN cookie, a 302 HTTP redirect, a JavaScript redirect, CAPTCHA action, dropping a user request, and the like. In an exemplary and non-limiting configuration, the security servers 120-1, 120-2, and 120-M are respectively configured to perform a CAPTCHA action, a SYN cookie action, and a JavaScript redirect action. It should be noted that other configurations may be apparent to one of ordinary skill. For example, security server 120-2 can be configured to perform both a JavaScript redirect and a 302 HTTP redirect action.

According to certain exemplary configurations, an attack detection device 160 is communicatively connected to the central controller 101. The device 160 is configured to provide the central controller 101 with information about, for example, the network conditions, potential attacks, and so on. Based, in part, on the information received from device 160, the controller 101 is configured to execute the escalation policy and program the network elements 102 with routing decisions that they should take accordingly.

In an exemplary embodiment, the attack detection device 160 is further configured to detect network and application denial of service (DoS) and DDoS attacks, web screen scraping activities, application brute force attacks, application scans (e.g. pre attack application vulnerability probe), web SPAM activities, and the like. Such detection may be achieved based on network and bandwidth statistics, such as an average number of active connections, an average number of packets received per second, application request rate, application request distribution, techniques of matching to suspicious pre-defined traffic patterns, and other attack detection methods known in the related art. In one embodiment, the detection capabilities of the device 160 are implemented in the central controller 101.

According to various embodiments disclosed herein, the central controller 101 is configured to provide a distributed security solution for detection and mitigation of cyber threats associated with misuse of computing and application resources. Such threats include, but are not limited to, network and application DoS and DDoS attacks, web screen scraping activities, application brute force attacks, web SPAM activities, and so on. The mitigation is performed by means of the plurality of security servers 120. Specifically, the central controller 101 is configured to program the network elements 102 to steer traffic to one or more of the security servers 120 according to an escalation security policy defined for the clients or one of its users and a computed risk state. In one embodiment, the traffic steering is also based on the availability of the one or more of security servers 120. The risk state is computed for a user of each client 140, through the SDN 100.

In one embodiment, a user of client 140 can be identified by the client 140 IP source address. In another embodiment, a user of the client 140 may be identified using layer-7 (of the OSI model) parameters, such as user name, or by means of an identity manager device 170. In an optional configuration, the identity manager device 170 is communicatively connected to the central controller 101 and is utilized to provide the identity of the user of a client 140. The device 170 may be, for example, an enterprise or a carrier's user management (AAA) device.

The escalation security policy defines the security (authentication) actions for each risk state and their order of execution. The policy is defined in such a way as to allow maximizing the security protection while minimizing the disturbances to the user's activity and the number of false positives. It should be noted that different escalation policies may be determined for different users of clients. For example, if both user-A and user-B can access the protected destination server, then a different policy may need to be determined for each such user. If multiple clients have access to the destination server 130, then multiple policies can be defined for the multiple clients. The central controller 101 can also be configured with templates of escalation policies thereby allowing a system administrator to modify the template to address new threats on the fly.

The risk state is related to the risk that a user poses to a destination server. In one embodiment, the risk state is determined for a user of each client 140 based on a plurality of security risk indication parameters, including for example a pre-compiled list of trusted clients per IP address, a reputation score per IP address or geographical region, application layer parameters (e.g., clients' cookies), a client unique identification (ID) token, user ID, an affiliation of a client (e.g., a client belongs to a trusted company or is an internal client of the organization), parameters collected from external and internal client authentication services, a type of content and/or application accessed by the client, behavioral analysis (e.g., comparing the clients' behavior to a normal behavior of the client), and so on.

A non-limiting example for an escalation security policy is provided in Table 1.

TABLE 1

| | | Security Actions | |
|---|---|---|---|
| | Risk State | and their order | Exceptions |
| 1 | Low | SYN Cookie | None |
| 2 | Medium | SYN Cookie, JS | Perform only first |
| | | redirect | action if succeed |
| 3 | High | SYN Cookie, JS | Perform all actions if |
| | | redirect, CAPTCHA | the threat is maintained |
| 4 | Severe | CAPTCHA | None |

As can be noted from this exemplary escalation policy, each risk state is associated with a different set of actions, where for higher risks more aggressive security actions are taken. That is, at low risk only a SYN cookie may be implemented to mitigate the threat, but at a severe risk, CAPTCHA action should be taken. The order of their actions escalates from non-aggressive (i.e., action that will not affect the client) to aggressive actions. As an example, a SYN Cookie, then a JS redirect, and finally a CAPTCHA action.

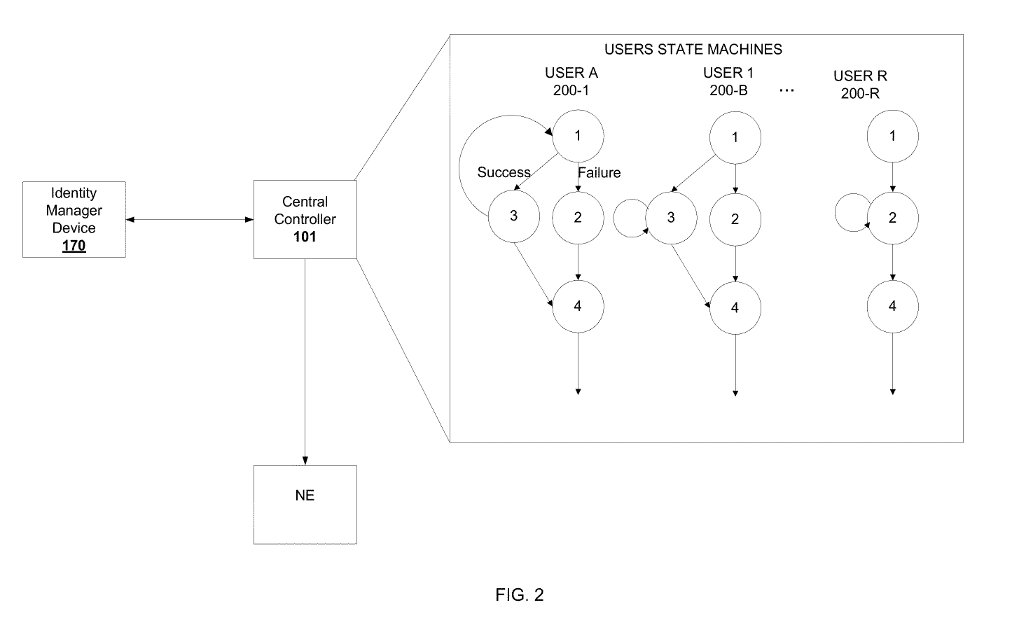

In one embodiment, the escalation policy and its execution is realized by means of a user state machine. For each user, the central controller 101 maintains a state machine indicating the sequence of security actions that should be executed and the update status of each action, e.g., whether a SYN cookie passed/failed for a user-A. An exemplary and non-limiting diagram illustrating the user state machines 200-1 through 200-R maintained by the central controller 101 is provided in FIG. 2. It should be noted that similar user state machines can also be maintained for the plurality of clients 140.

The central controller 101 is also configured with the information about the capabilities and availability of each of the security servers 120. That is, which action the server 120 performs and whether it is available to perform the action. With this aim, the central controller 101 monitors the health and load of each security server 120, for example, by sending a ping message to the server 120, by simulating an application request that will be challenged by the server, and/or by requesting load status (e.g., a number of concurrent processed transactions by the server), and so on. Once a failure or a high load is identified on a specific server, the central controller 101 is configured to utilize a redundant security server action (performing the same action as the failed/loaded server), if such exists. If such a server response does not exist, and optionally per administrator's configuration, then the security server performing the next security action defined in the policy is utilized as a backup server. Furthermore, when switching over to the redundant/backup server, the central controller 101 continues with the execution of the escalation policy from the last state performed prior to the switch over.

In another embodiment, the central controller 101 is configured to load balance clients' requests among a plurality of security servers that can perform the same or a different challenge. For example, if the security server 120-1 is overloaded, clients' requests that required a SYN cookie challenge will be uniformly distributed among the security server 120-1 and its redundant servers (not shown). With this aim, the central controller 101 programs the network elements with different routes, and the selection of the route is made based on one or more load balancing criteria, such as current load of each security server, cost, round robin, combination thereof, and so on.

Through the execution of the escalation policy respective of the user, the central controller 101 is configured to divert the incoming traffic, addressed to the destination server 130, to the security server 120 that should perform the current action based on the policy. For example, for the policy defined in Table 1, if the risk state is Medium and the current action that should be taken is a SYN cookie, the traffic from the client (e.g., client 140-1) is diverted to the security server 120-1. If the SYN cookie operation fails, the central controller 101 is configured to divert the traffic to the security server 120-M which performs the JS redirect action. If the challenge action succeeds, the original path from the client 140-1 to the destination server 130 is computed, to route subsequent flows to the destination server 130.

In order to divert the incoming traffic, addressed to the destination server 130, the central controller 101 is configured to program the network elements 102 to perform this task. The programing of the network elements 102 may include changing the flow tables of the network elements and/or instructing the elements to divert the traffic based on a diversion value designated in a diversion field.

In one embodiment, the central controller 101 is configured to instruct the peer network elements to designate and clear the designation of all packets having the same network parameter. The network parameter may be, for example, a source IP address, a destination IP address, a destination port, or any combination thereof.

A peer network element is a network element of the SDN that the incoming traffic flows through. For example, an element 102-1 is a peer network element. An edge network element is a network element directly connected to a security server 120, i.e., all traffic from and to a security server 120 flows through the edge network element. In the exemplary FIG. 1, elements 102-2, 102-3, and 102-4 are edge network elements.

According to one embodiment, the designation instructions include setting a “diversion field” in a header of the packet to a predefined value. The diversion field may be a pre-defined field in the IP (Layer-3) header or an Ethernet/MAC (Layer-2) header. Different embodiments for designating the packets are disclosed herein below.

As mentioned above, the central controller 101 can modify the flow tables at the network elements 102, or can make any other supported programming operation, such that each element should know where to forward an incoming packet based on the value in the diversion field. The embodiments disclosed herein enable diversion of suspicious traffic on-the-fly without prior provisioning of the network elements by a network administrator.

According to one embodiment, the central controller 101 communicates with the network elements 102 of the network 100 using the OpenFlow protocol, discussed above, through a secure channel established with each network element 102. According to another embodiment the SDN 100 may be operated according to protocols of other virtual networks, including but not limited to overlay networks and the like. An SDN-based overlay networking architecture is based on an overlay logical link established over the physical transport network. Overlay logical links are tunneled through the underlying physical networks using dedicated tunnel encapsulation performed by network virtualization edge devices, such as virtual switches and dedicated overlay gateways.

The disclosed escalation method is also applicable to hybrid networks in which a SDN is a sub-network of a conventional network, whereby its elements cannot be programmed by a central controller. To allow the proper operation of the escalation method disclosed above in the hybrid network, network elements in the diversion path (i.e., from the peer network element to a security server) that are not SDN enabled should be adapted to allow programmability. This can be performed through dynamic networking routing techniques, such as virtual overlay network routing techniques operable with legacy networking elements that are controlled by the central SDN controller (e.g., central controller 101).

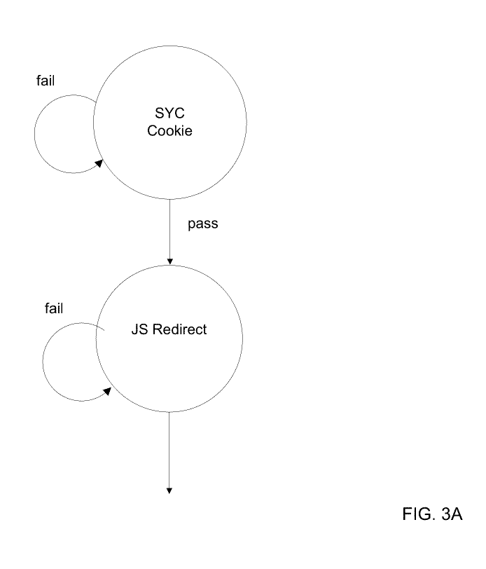

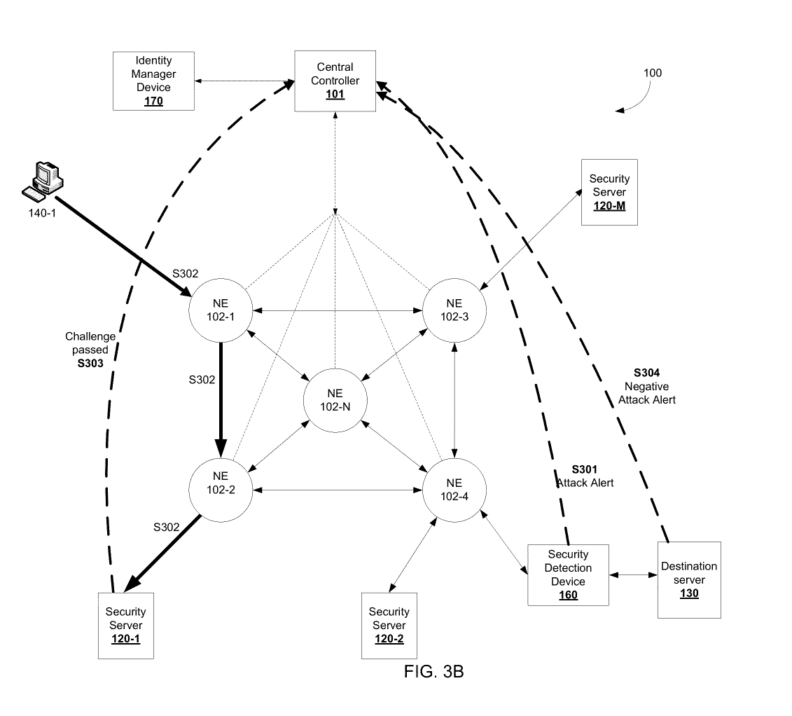

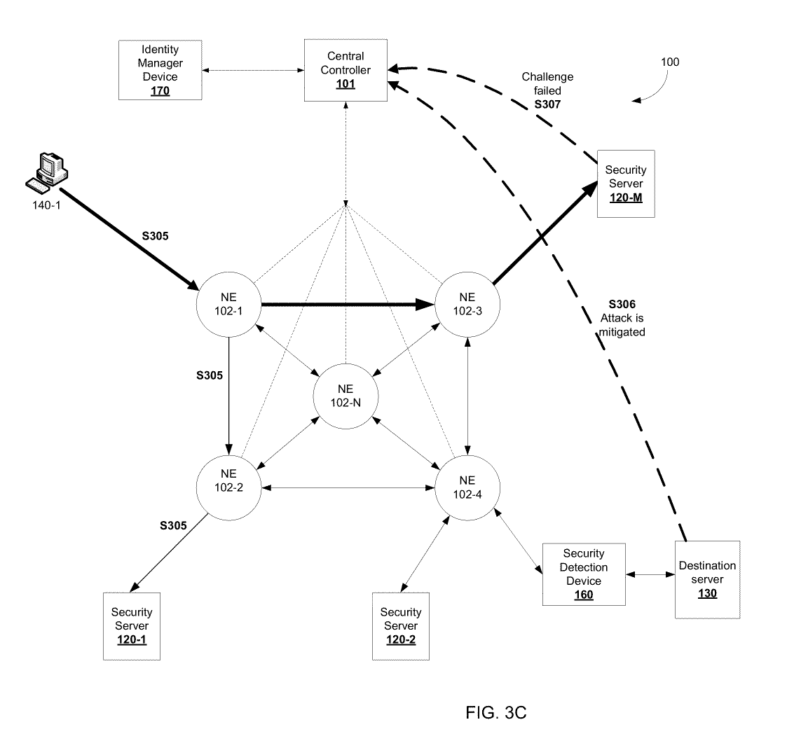

FIGS. 3A, 3B, and 3C illustrate exemplary and non-limiting diagrams for the operation of the disclosed escalation method when processing traffic from one user according to an embodiment. In this example, the actions to be performed include a SYN cookie (performed by server 120-1) and a JS redirect (performed by the server 102-3). An exemplary and non-limiting diagram of a state machine realizing the escalation policy performed according to this example is shown in FIG. 3A.

Referring now to FIG. 3B, at S301, a potential attack is detected and reported to the controller 101. At S302, a user traffic directed to the destination server 130 is received from client 140-1. The controller 101 instructs the peer network element 102-1 to divert the traffic to the edge network element 102-2 connected to the server 120-1. The client traffic received at the server 120-1 is challenged. That is, the security server 120-1 sends a TCP challenge (e.g., a SYN cookie) to verify the IP address of the client 140-1, i.e., to determine if such address is a spoof. The status of the challenge (i.e., fails or passes) is reported to the controller 101 (S303). In this example, the SYN cookie challenge passes. The controller 101 inquires about the status of the attack, for the purpose of updating the risk state and to determine the next action to be taken. As reported by the server 130 the attack has not been mitigated (S304).

Referring now to FIG. 3C, the execution of the escalation policy should be continued. Thus, at S305, traffic from the client 140-1 is diverted to the security server 120-M through the peer and edge network elements 102-1 and 102-3 respectively. The server 120-M performs a JS redirect challenge. At S306, an indication that the attack has been mitigated is received at the controller 101. At S307, it is also reported by the security server 120-M that the challenge failed. As a result, the controller 101 instructs the peer and edge network elements 102-1 and 102-3 to continuously direct traffic from the client 140-1 to the server 120-M until the JS redirect challenge passes and the attack is mitigated.

In one embodiment, the peer network element 102-1 can be instructed to block traffic incoming from a client 140 if its respective user does not pass a maximum number of allowed consecutive challenge attempts. For example, if a user of a client 140-1 does not pass a challenge after maximum predefined number of attempts, incoming traffic from the client 140-1 of a respective user would not be diverted to the security server 120, but instead would be blocked. As the central controller 101 receives the status of challenges for each client, the controller 101 can count the number of attempts to pass a challenge or the number of times that the client requested to open a new connection. The central controller 101 can program the peer network element 102-1 to block incoming traffic by reconfiguring an access control list (ACL) of the network element with the IP address from which traffic should be blocked. It should be noted that by blocking users that were determined to be attackers at the network element at the edge of the network, continuous challenge attempts are not needed, thus unnecessary processing tasks are offloaded from the security servers and the entire network elements.

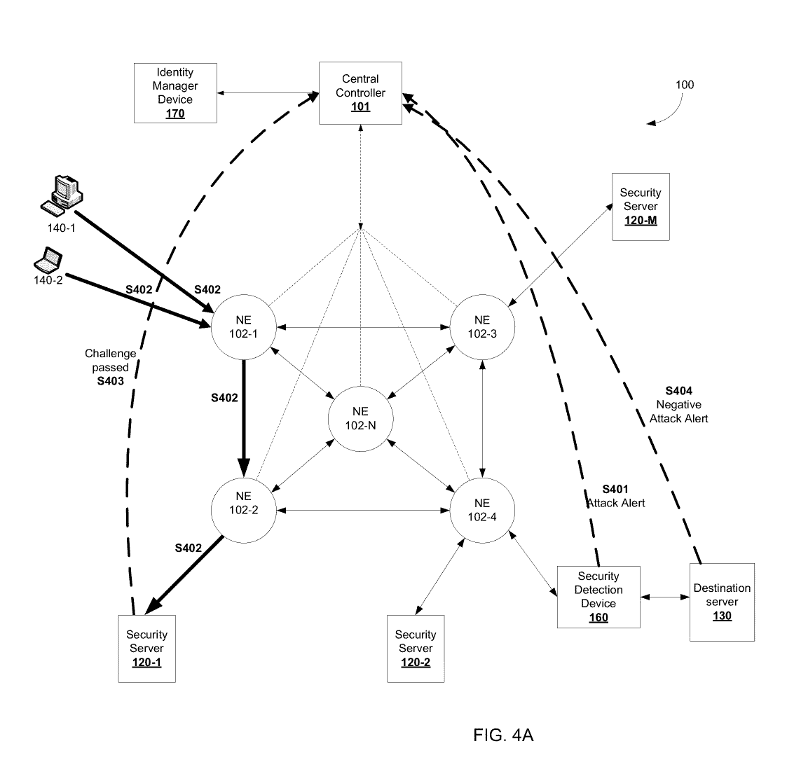

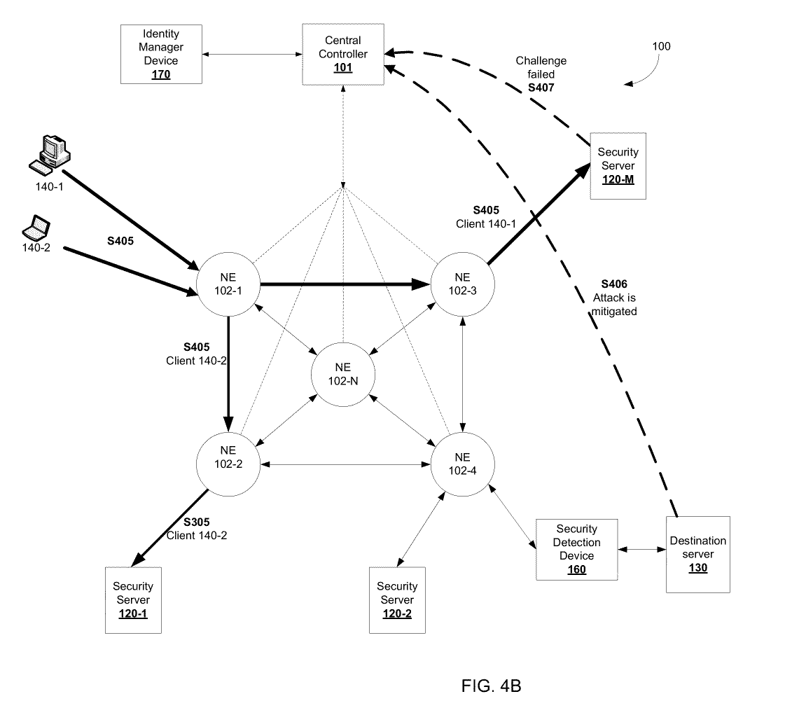

FIGS. 4A and 4B illustrate exemplary and non-limiting diagrams for the operation of the disclosed escalation method when the escalation policy is executed for two different clients 140-1 and 140-2. Also in this example, the actions to be performed include SYN cookie (performed by server 120-1) and JS redirect (performed by the server 102-3). The escalation policy defined for the users of clients 140-1 and 140-2 is shown in FIG. 3A.

Referring now to FIG. 4A, at S401, a potential attack is detected and reported to the controller 101. At S402, a user traffic directed to the destination server 130 is received from clients 140-1 and 140-2. The controller 101 instructs the peer network element 102-1 to divert the traffic to the edge network element 102-2 connected to the server 120-1. The clients' 140-1 and 140-2 are challenged by the server 120-1. That is, the security server 120-1 sends a TCP challenge to verify the IP address of the client 140-1 and 140-2 to determine if such address is a spoof.

The status of challenge fails/passes is reported to the controller 101 (S403). In this example, the SYN cookie challenge for client 140-1 passes and for client 140-2 fails. The controller 101 inquires about the status of the attack, for the purpose of updating the risk state and to determine the next action to be taken. As reported by the server 130 the attack has not been mitigated (S404).

Referring now to FIG. 4B, the execution of the escalation policy should be continued. Thus, at S405, the traffic from the client 140-1 is diverted to the security server 120-M through the peer and edge network elements 102-1 and 102-2 respectively. The server 120-M performs a JS redirect challenge. At the same time, the traffic from the client 140-2 is diverted to the security server 120-1 through the peer and edge network elements 102-1 and 102-3 respectively, to continue the SYN cookie challenge for this client 140-1. At S406, an indication that the attack has been mitigated is received at the controller 101. At S407, it is also reported by the security server 120-3 that the challenge for the client 140-1 failed. As a result, the controller 101 instructs the peer and edge network elements 102-1 and 102-3 to continuously direct traffic from the client 140-1 to the server 120-M until the JS redirect challenge passes, and the attack ends.

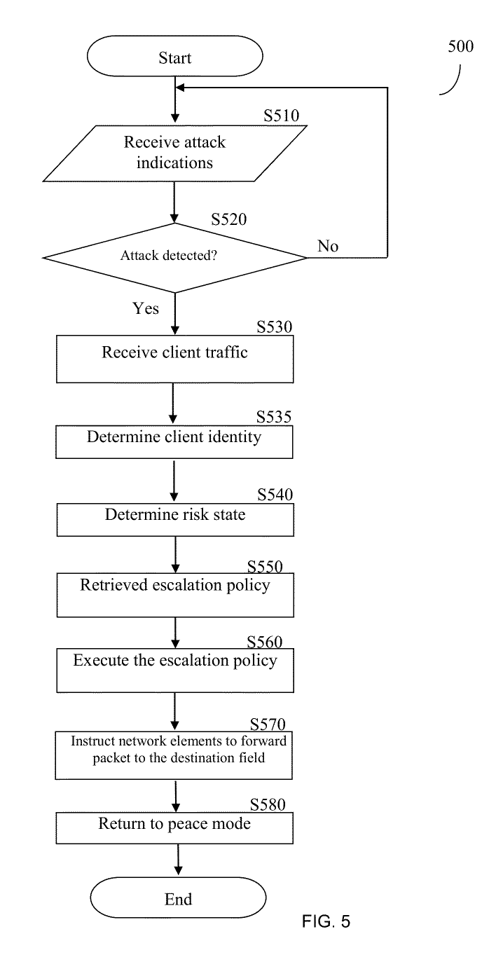

FIG. 5 shows an exemplary and non-limiting flowchart 500 illustrating the operation of the escalation method disclosed in accordance with one embodiment. As discussed in detail above, the method is performed by a central controller operable in a SDN. For the mere sake of simplicity, the method will be discussed with reference to applying the escalation policy to one client. However, as discussed in detail above, the escalation method can be performed for multiple users of clients concurrently accessing the destination server.

There are two modes of operation for the central controller 101 and the SDN 100, “peace mode”, and “attack mode”. During the peace mode, the central controller 101 is configured to program all network elements 102 to perform the required regular routing and forwarding of packets. That is, all network elements 102 are programmed to forward incoming IP packets based only on their destination IP or MAC addresses as typically performed, for example, by conventional routers or switches. In the attack mode, the clients' traffic is diverted according to the escalation policy defined for the user.

At S510, at least an attack indication, or potential threats to the destination server, is received. The attack indications may include, for example, an attack alarm from the device 160, a high number of active connections, a high number of packets received per second, an indication that an incoming traffic is from an IP address included in a black list, indications collected from client authentication services (e.g., Radius servers, LDAP servers, “call-back” procedures, etc.), geo analysis information (e.g., the origin of a client's traffic in comparison to other clients), a type of content and/or application accessed by the client, behavioral analysis (e.g., comparing the clients' behavior to a normal behavior of the client), and so on. Alternatively or collectively, the controller 101 may be configured to analyze the attack indications to determine if an attack is being committed against the destination server 130.

At S520, a check is made to determine if a potential threat has been detected, and if so execution continues with S530; otherwise, execution returns to S510. A potential attack may be associated with a destination IP address of the destination server 130 that receives the suspicious traffic. Alternatively or collectively, a potential attack may be associated with a source IP address of a client that generates the suspicious traffic.

At S530, an incoming traffic is received from a client, e.g., a client 140-1. At S535, the client identity is determined using, for example, the source IP address. In addition, the user of the client may be also identified. This can be performed using an identity manager device 170 or by analyzing layer-7 parameters in the incoming traffic.

At S540, the risk state of the client identified at S530 is computed. As discussed earlier such computation is performed using a plurality of security risk indication parameters. According to an exemplary and non-limiting embodiment, the risk state of the client is defined by a deterministic value, such as low, medium, high and severe.

At S550, an escalation security policy predefined for the user of the client is obtained. The policy may be obtained, for example, from the central controller's memory 101 or a data repository (not shown) connected to the controller 101. In one embodiment, the controller 101 may be pre-loaded with escalation policies designed for different users that can access the destination server 130. As noted above, each escalation policy defines for each risk state, the security actions that should be performed, and the particular order of the execution of such actions, and exceptions that may be associated with the execution of the actions. As noted above, each escalation policy may be realized as a user state machine.

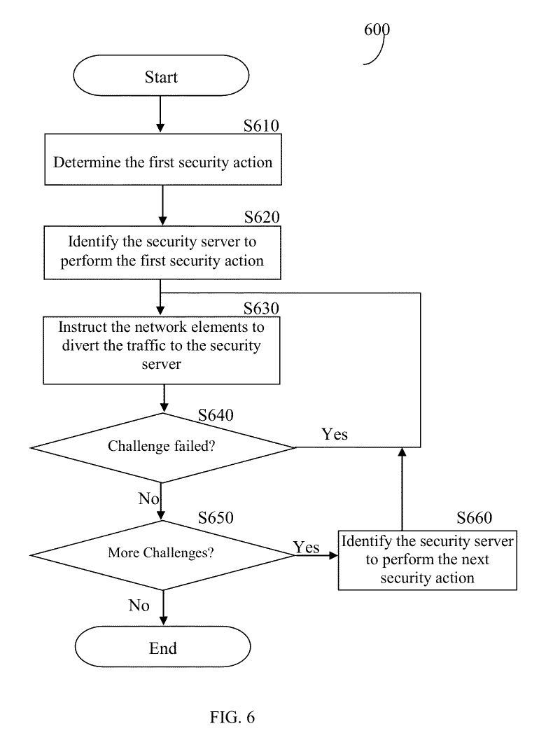

At S560, the escalation policy retrieved at S550 is carried out. With this aim, incoming traffic from the client is diverted to one or more or the security servers under the control of the central controller 101. The operation of S560 is discussed in further detail with reference to FIG. 6.

Referring to FIG. 6, at S610, the first security action defined in the escalation policy is determined. At S620, the security server configured to perform the first escalation server is identified. At S630, the peer network element and any network element between the peer network element and the edge network are instructed, by the central controller, to route all incoming packets to the edge network element connected to the identified security server. For example, to divert traffic to the security network 120-1, the peer network element 102-1 is instructed to forward the incoming traffic to the edge network element 102-N (see FIG. 1).

In one embodiment, the diversion of traffic can be performed by configuring the flow tables of each network element of the SDN. This can be performed for example by means of the OpenFlow protocol. In another embodiment, traffic diversion is achieved by means of setting a diversion value in a diversion field of each packet. The diversion value is a unique number associated with the target security server. Accordingly, the central controller 101 instructs the peer network element to set the diversion field to a value associated with the target security server (e.g., server 120-1). Furthermore, the controller instructs all network elements connected in the SDN receiving a packet to direct the packet to the edge network element connected to the server associated with the diversion value designated in the packet.

The diversion field may be an existing field in an IP packet's header, e.g., a TTL field, a Hop Limit field, and the like. As another example, a source MAC address field in an Ethernet (Layer-2) header is utilized as the diversion field. The source MAC address is set to a pre-defined unique value that can be used as an indication to initiate diversion without any intervention and interruption to network operation. The diversion value of the diversion field is set by peer network elements, respective of the type of field being utilized in such a way that a network element 102 recognizes such value as not being a value conventionally used or defined by the IP protocol forwarding or Layer-2 switching.

At S640 a check is made if the challenge performed by the security server has failed, and if so execution returns to S630 where subsequent flows are also diverted to the security server. Otherwise, at S650, if the challenge passed, a check is made as to whether additional challenges should be made. The check is based on the current risk state, attack indication (positive or negative), and the current state of the user state machine realizing the escalation policy.

If S650 results with a Yes answer, at S660, a new security server is identified based on the current security challenge defined the escalation policy. Then, execution returns to S630 where incoming traffic from the client is diverted to the new security server using one of the diversion techniques mentioned above. If S650 results with a No answer, then execution of the escalation policy is completed.

Returning to FIG. 5, at S570 the network elements are instructed to divert traffic from the client to the destination server. This may include computing the route to the destination server, configuring the flow tables at the network elements, and/or clearing the diversion field value, if such a value was set. At S580, if no more threats exist in the network, the central controller's mode of operation is set to a peace mode.

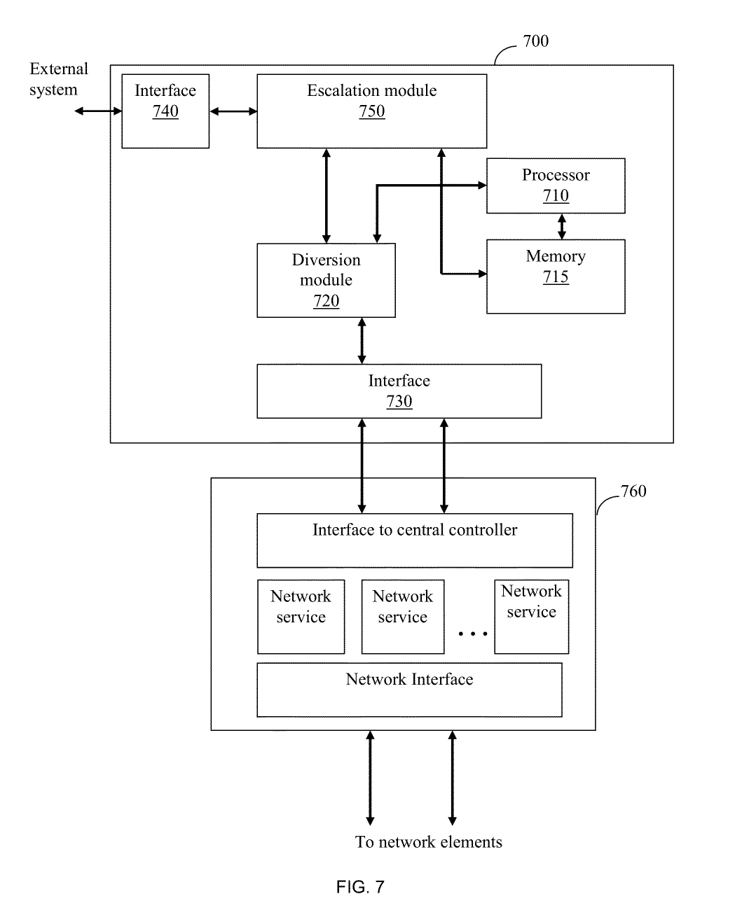

FIG. 7 shows an exemplary and non-limiting block diagram of the central controller 700 constructed according to one embodiment. The central controller 700 is operable in a SDN, such as those defined above, and is at least configured to execute the escalation method described in greater detail above. The central controller 700 includes a processor 710 coupled to a memory 715, a diversion module 720, a network-interface module 730, an interface 740 to an external system, and an escalation module 750.

The network-interface module 730 allows the communication with the network elements of the SDN. In one embodiment, such communication uses the OpenFlow protocol discussed above through a secure channel established with each network element. In another embodiment, the communication is achieved through another control channel (e.g., SNMP, CLI, SSH, etc.). The interface 740 provides an interface to an attack detection device, a security server, a user identity manager module, and the like.

The diversion module 720 is configured to allow traffic diversion in the SDN network. As noted above, the diversion module 720 is configured to determine a diversion route of traffic from clients to the security servers performing the challenging actions. In one embodiment, the diversion module 720 is configured to define the flow tables in each network element of the SDN. In another embodiment, the diversion module 720 is configured to determine a diversion value to be set in a diversion field and instructs the network elements as to how to forward the packets based on the diversion values. The module 720 communicates with an SDN network controller through the network-interface 730. The SDN network controller 760 is configured to program the network elements of the SDN and to provide various network services. The programming may include changing the flow tables and/or instructing the elements to divert traffic according to the diversion value. The SDN network controller 760 can also provide network services that include, for example, network topology discovery, routing methods/algorithms (e.g., shortest path forwarding), QoS, virtual network overlay services, and the like.

In certain possible configurations, each of the interfaces 730 and 740 is realized through a set of application programming interfaces (APIs) for communication with the SDN network controller 750 and the external network respectively. In another configuration, the module 720 may communicate with the network elements directly through the interface 730.

The escalation module 750 is configured to compute a risk state for each client/user, obtained from the memory 715 escalation policy associated with the client/user and the risk state, and to execute the escalation policy for each client as discussed above. The escalation module 750 also determines the security server that needs to handle the current challenge per client and instruct the diversion module 720 to divert the traffic to such server. The processor 710 uses instructions stored in the memory 715 to control and enable the operation of the diversion module 720, the network-interface module 730, and the interface 740. The memory 715 may also include preconfigured escalation policies and/or templates of such policies. As noted above, templates may be configured by a system administrator. The central controller 700 may also be connected to an external storage device for retrieving of escalation policies.

The various embodiments disclosed herein can be implemented as any combination of hardware, firmware, and software. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for performing an escalation security policy in a software defined network (SDN), the method is being performed by a central controller of the SDN, comprising:
receiving at least one attack indication performed against at least one destination server;
upon determination, respective of at least one attack indication, that an attack is being performed against the at least one destination server, for each client sending traffic to the at least one destination server:
determining a risk state for a user of the each client;
obtaining an escalation security policy respective of the determined risk state of the user, wherein the escalation security policy defines a sequence of at least one challenge action for challenging the each client, an order and at least one condition for execution of the sequence of at least one challenge action; and
causing network elements of the SDN to divert incoming traffic from the each client to security servers connected to the SDN and configured to perform the at least one challenge action.

2. The method of claim 1, further comprising:
monitoring at least one of health and load of each of the security servers; and
switching over to a redundant security server when a respective security server is determined to be nonfunctional or overloaded.

3. The method of claim 2, further comprising:
load balancing clients' traffic among the security servers performing the same challenge action, when the respective security server is determined to be overloaded.

4. The method of claim 1, further comprising checking the identity of the user using at least one of: a source Internet protocol (IP) address of its respective client, application layer parameters, and an identity manager device.

5. The method of claim 1, wherein diverting the incoming traffic further comprising:
diverting the incoming traffic to the security servers according to the order of execution of the sequence of the at least one action and the condition defined in the respective execution security policy.

6. The method of claim 5, wherein the at least one condition defined in the escalation policy includes at least one of: a status of the attack and a status of the at least one challenge action.

7. The method of claim 6, further comprising:
selecting a first challenge action out of the at least one challenge action, wherein the first challenge action is selected respective of the risk state, the status of the attack, and a sequence order defined in the escalation security policy;
selecting a security server out of the security servers configured to perform the first challenge action; and
causing the network elements of the SDN to divert incoming traffic to the selected security server.

8. The method of claim 7, further comprising:
checking the status of the first challenge action;
selecting a second challenge action, when the status of the first challenge action indicates that the first challenge action has passed;
selecting a security server out of the security servers configured to perform the second challenge action; and
causing the network elements of the SDN to divert incoming traffic to the selected security server.

9. The method of claim 8, wherein the second challenge action is more aggressive than the first challenge action.

10. The method of claim 8, further comprising:
programing a peer network element to block the incoming traffic if the status of the challenge action indicates that any of the first and second challenge actions has failed during a predefined number of consecutive challenge attempts.

11. The method of claim 8, further comprising:
computing a route from the each client to the at least one destination server, when the attack is mitigated and when the status of the challenge action indicates that any of the first and second challenge actions has passed; and
diverting traffic to the at least one destination server over the computed route.

12. The method of claim 5, wherein causing network elements of the SDN to divert incoming traffic from the each client to security servers further comprising: at least one of: programming each network element in the SDN to forward a packet based on a diversion value designated in a packet diversion field; and configuring a flow table of each network element.

13. The method of claim 12, wherein programming each network element in the SDN to forward a packet based on a diversion value further comprising:
instructing at least one peer network element in the SDN to mark a diversion field in each packet in the incoming traffic addressed to the security servers, wherein each network element in the SDN receiving the packet with the marked diversion field is programmed to divert the packet to security servers.

14. The method of claim 1, wherein the attack indication includes at least one of: an attack alarm from an attack detection device, a high number of active connections, a high number of packets received per second, an indication that an incoming traffic is from an Internet Protocol (IP) address included in a black list, an indication received from a client authentication service, geo-analysis information, a type of content accessed by the client, and behavioral analysis.

15. The method of claim 1, wherein the user risk state is assigned with a deterministic value.

16. The method of claim 15, wherein the user risk state is determined based on a plurality of security risk indication parameters, wherein the security risk indication parameters include at least a pre-compiled list of trusted clients per IP address, a reputation score per IP address, a reputation score per geographical region, application layer parameters, a client unique identification token, the user identity, a client affiliation, a type of content accessed by the client, a challenge action result and behavioral analysis.

17. The method of claim 1, wherein the at least one challenge action includes any one of: a SYN cookie, a web redirect, a JavaScript redirect, and CAPTCHA.

18. The method of claim 1, wherein the escalation security policy is realized through a state machine, wherein the central controller maintains at least one state machine for the each user.

19. The method of claim 1, wherein the at least one peer network element is a network element of the SDN through which the incoming traffic addressed to the at least one destination server flows through.

20. The method of claim 19, wherein an OpenFlow protocol is utilized for communication between the network elements and the central controller.

21. A non-transitory computer readable medium having stored thereon instructions for causing one or more processing units to execute the computerized method according to claim 1.

22. A system for performing an escalation security policy in a software defined network (SDN), comprising:
a processor;
a network-interface module for communicating with the SDN;
a memory connected to the processor and configured to contain a plurality of instructions that when executed by the processor configure the system to:
receive at least one attack indication performed against at least one destination server;
upon determination, respective of at least one attack indication, that an attack is being performed against the at least one destination server, for each client sending traffic to the at least one destination server:
determine a risk state for a user of the each client;
obtain an escalation security policy respective of the determined user risk state, wherein the escalation security policy defines a sequence of at least one challenge action for challenging the each client, an order and at least one condition for execution of the sequence of at least one challenge action; and
cause network elements of the SDN to divert incoming traffic from the each client to security servers connected to the SDN and configured to perform the at least one challenge action.

23. The system of claim 22, wherein the network-interface module is configured to interface with the SDN through a SDN network controller, wherein the SDN network controller is configured to communicate and program network elements of the SDN.

24. A system for performing an escalation security policy in a software defined network (SDN), comprising:
a network-interface module for communicating with the SDN;
a system-interface for receiving at least one attack indication performed against at least one destination server;
an escalation module for determining whether an attack is being performed against the at least one destination server, wherein upon determination of that the attack is being perform, the escalation module is configured to:
determine a risk state for a user for the each client sending traffic to the at least one destination server;
obtain an escalation security policy respective of the determined user risk state, wherein the escalation security policy defines a sequence of at least one challenge action for challenging the each client, an order and at least one condition for execution of the sequence of at least one challenge action; and
a diversion module for causing network elements of the SDN to divert incoming traffic from the each client to security servers connected to the SDN and configured to perform the at least one challenge action.

25. The system of claim 24, wherein the network-interface module is configured to interface with the SDN through a SDN network controller, wherein the SDN network controller is configured to communicate and program network elements of the SDN.

26. The system of claim 24, wherein the system interface is configured to interface with an external system, wherein the external system is any one of an attack detection tool and an identity manager device.

27. The system of claim 25, wherein an OpenFlow protocol is utilized for communication between the network elements and any of at least one of the SDN network controller.
